(19) United States
(12) Patent Application Publication
(10) Pub. No.: US 2024/0114263 A1
(43) Pub. Date: Apr. 4, 2024

(54) MULTI-MODE IMAGE SENSOR ARCHITECTURE

(71) Applicant: Meta Platforms Technologies, LLC, Menlo Park, CA (US)

(72) Inventors: Andrew Samuel Berkovich, Sammamish, WA (US); Xinqiao Liu, Medina, WA (US); Onur Can Akkaya, Los Altos, CA (US); Tsung-Hsun Tsai, Redmond, WA (US); Song Chen, Redmond, WA (US); Lyle David Bainbridge, San Francisco, CA (US)

(21) Appl. No.: 18/479,765

(22) Filed: Oct. 2, 2023

Related U.S. Application Data
(60) Provisional application No. 63/412,763, filed on Oct. 3, 2022.
(60) Provisional application No. 63/426,897, filed on Nov. 21, 2022.

(51) Int. Cl. H04N 25/772; H04N 25/531; H04N 25/532

(52) U.S. Cl. CPC H04N 25/772; H04N 25/531; H04N 25/532

(57) ABSTRACT

An image-sensing system includes multiple sensing modules. Each of the multiple sensing modules includes multiple optical sensors arranged in an array. Each of the multiple sensors is configured to be switched on and off to generate analog sensing data. The image-sensing system also includes an analog-to-digital converter (ADC) shared by the multiple optical sensors configured to convert analog sensing data generated by the multiple optical sensors into digital data. The image-sensing system also includes a processor configured to control the multiple sensing modules.

### CROSS REFERENCE TO RELATED APPLICATIONS

This application claims priority to U.S. Provisional Application No. 63/412,763 filed Oct. 3, 2022, and U.S. Provisional Application No. 63/426,897 filed Nov. 21, 2022, both of which are incorporated by reference.

### TECHNICAL FIELD

The subject matter described herein relates generally to image sensors, and more specifically to a multi-mode image sensor architecture.

### BACKGROUND

Vision systems commonly use distinct R (red) G (green) B (blue) or monochrome sensors alongside D (depth) sensors. This results in the depth and color sensors capturing slightly varied views of a scene, leading to what is known as parallax issues. This can be particularly problematic for applications that depend on combined RGB-D data, such as mixed or virtual reality pass through and 3D mapping. These applications may suffer from incomplete data or visual glitches because the depth sensor captures something that the color sensor misses.

Further, high-definition RGB data is often expected for applications aimed at human users, such as point-of-view capture and mixed or virtual reality (VR) passthrough. This typically requires sensor resolutions in the multi-megapixel (MP) range (e.g., 12 MP or 16 MP). However, the compact designs that are desirable for augmented reality (AR) and VR systems often pushes pixel size down towards the sub-micron range. Many existing depth solutions, like indirect Time-of-Flight (iToF) and direct Time-of-Flight (dToF), can capture both color and depth in a single sensor but struggle to scale to the smaller pixel sizes used for high resolution displays.

### SUMMARY

Embodiments described herein solve the above-described problems by aligning RGB and depth sensors spatially to enable capturing RGB and depth frames simultaneously. Such embodiments can mitigate problems arising from movement, thereby streamlining computation and reducing energy usage.

Further, in AR/VR applications, combining different types of sensors into a single unit offers additional advantages, including (but not limited to) lowering the overall cost of materials, enhancing the design form factor, reducing power consumption, and simplifying system integration by minimizing the need for additional components like D-PHY (Dedicated Physical Layer) lanes. Because using separate sensors for RGB, monochrome, and depth features limits the kind of systems that can be designed, an integrated sensor that can perform all these functions is highly desirable. In one embodiment, an image-sensing system includes a plurality of sensing modules (which may or may not be same), an analog-to-digital converter (ADC), and a processor. Each of the sensing modules includes a plurality of optical sensors arranged in an array. Each of the plurality of optical sensors is configured to be switched on and off to generate analog sensing data. The ADC is shared by the plurality of optical sensors. The ADC is configured to convert analog sensing data generated by the plurality of optical sensors into digital data. The processor is configured to control the plurality of sensing modules.

In another embodiment, a method of capturing an image uses an image-sensing system having a plurality of sensing modules, each of which includes an array of pixel sensors. The method includes selecting one of a plurality of modes in which the image-sensing system can operate. The plurality of modes includes at least a rolling shutter (RS) mode and a global shutter (GS) mode. Responsive to selecting the RS mode, at least one pixel sensor in each of the sensing modules is selected and activated sequentially. Responsive to selecting the GS mode, at least one pixel in each of the sensing module is selected and activated simultaneously.

In a further embodiment, a sensing module includes a plurality of optical sensors and an analog-to-digital converter (ADC). Each of the plurality of sensors is configured to be switched on and off to generate analog sensing data. The ADC is shared by the plurality of optical sensors configured to convert analog sensing data generated by the plurality of optical sensors into digital data. The sensing module is configured to be coupled with a second sensing module to capture a single frame of image.

### BRIEF DESCRIPTION OF THE DRAWINGS

FIGS. 1A-1F illustrate various examples of 4×4 multi-pixel sensing arrays in accordance with some embodiments.

FIG. 2 illustrates an example of a 16×16 multi-pixel sensing array in accordance with one or more embodiments.

FIG. 3 illustrates an example of six identical sensing modules corresponding to the sensing array shown in FIG. 2 being arranged in a 3×2 array to form a sensing system having an overall sensing array of 48×32 pixels in accordance with one or more embodiments.

FIG. 4 illustrates an example spatially-varying filter array including 42(=6×7)4×4 sensing modules in accordance with one or more embodiments.

FIG. 5 illustrates an example architecture of the sensing module in accordance with one or more embodiments.

FIG. 6 illustrates an example circuit diagram for a 4×4 sensing module in accordance with one or more embodiments.

FIG. 7 illustrates an example circuit diagram for a 4×4 sensing module, in which a sensing pixel has four blocks of 2×2 pixel sensors, in accordance with one or more embodiments.

FIG. 8 illustrates an example image-sensing system in accordance with one or more embodiments.

FIG. 9 illustrates an example image-sensing system in accordance with one or more embodiments.

FIG. 10 illustrates an example circuit for implementing temporal contrast in accordance with one or more embodiments.

FIG. 11 illustrates an example of a sample timing diagram according to one or more embodiments.

FIG. 12A illustrates an example timing diagram for rolling reset and global reset in sensing blocks with IR pixels in accordance with one or more embodiments.

FIG. 12B illustrates an example timing diagram for rolling reset and global reset in sensing blocks with HDR pixels in accordance with one or more embodiments.

FIG. 13A is a perspective view of a headset implemented as an eyewear device, in accordance with one or more embodiments.

FIG. 13B is a perspective view of a headset implemented as an HMD, in accordance with one or more embodiments.

### DETAILED DESCRIPTION

Embodiments described herein include an image-sensing system. The image-sensing system includes multiple sensing modules. Each sensing module includes multiple optical sensors (also referred to as “pixel sensors”) arranged in an array (e.g., an N×M array) and an analog-to-digital converter (ADC) shared by the multiple optical sensors, M and N are natural numbers, and at least one of M and N is greater than 1. Each optical sensor is configured to be switched on and off sequentially to generate analog sensing data. The ADC is shared by the multiple optical sensors and configured to convert analog sensing data generated by each of the multiple optical sensors into digital data. In some embodiments, the multiple sensing modules are identical. In some embodiments, the multiple sensing modules are different. In some embodiments, only a subset of the multiple sensing modules include an infrared sensor.

In some embodiments, the sensing module includes one or more monochrome sensors. In some embodiments, the sensing module includes one or more red sensors, one or more green sensors, and one or more blue sensors. In some embodiments, the sensing module includes one or more infrared sensors.

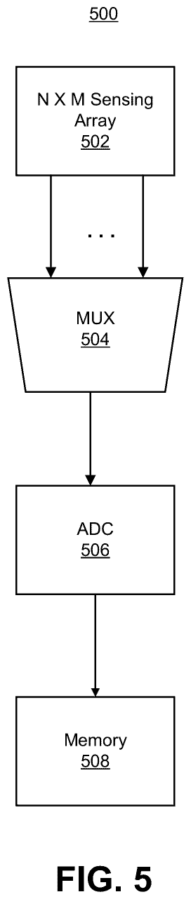

In some embodiments, the image-sensing system further includes a controller configured to operate the multiple sensing modules in various modes, such as (but not limited to) rolling shutter (RS) mode, global shutter (GS) mode, binning mode, and/or scanning depth sensing mode. In RS mode, rows of the multiple sensing modules are sequentially activated to capture images row by row. In GS mode, the multiple sensing modules are simultaneously activated to capture images simultaneously. However, since each sensing module includes multiple optical sensors that share a single ADC, the RS mode or GS mode described herein is different from the RS mode or GS mode in traditional image-sensing systems. Additional details about RS mode and GS mode are described below with respect to FIGS. 5-11.

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

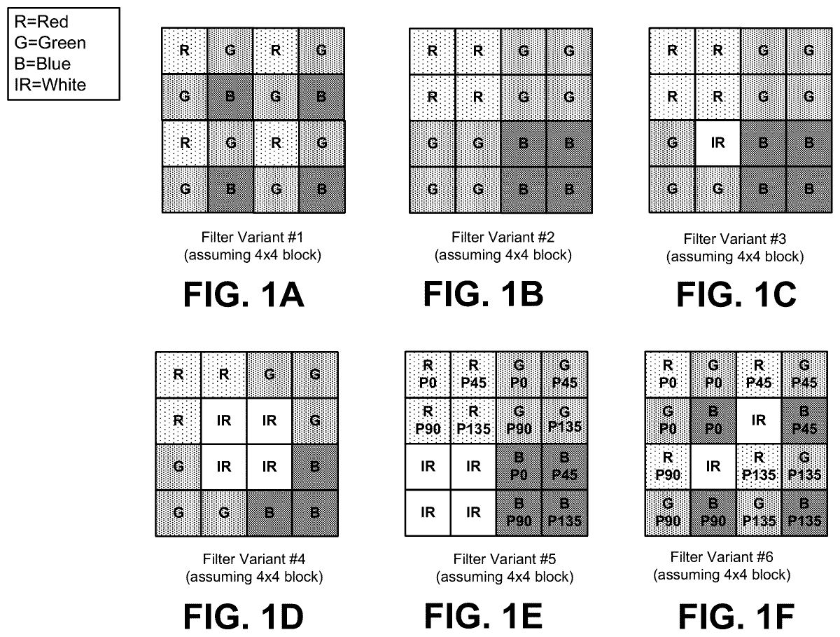

As briefly described above, an image-sensing system includes multiple sensing modules, and each sensing module may include an N×M array of optical sensors (also referred to as “pixel sensors”), M and N are natural numbers, and at least one of M and N is greater than 1. FIGS. 1A-1F illustrate various examples of 4×4 array of optical sensors in accordance with some embodiments. In FIG. 1A, each of a first row and a third row of four pixels are arranged in a red-green-red-green pattern, and each of a second row and a fourth of four pixels are arranged in a green-blue-green-blue pattern. In FIG. 1B, each of a first row and a second row of four pixels are arranged in a red-red-green-green pattern, and each of a third row and a fourth row of four pixels are arranged in a green-green-blue-blue pattern. In FIG. 1C, each of a first row and a second row of four pixels are arranged in a red-red-green-green pattern, a third row of four pixels are arranged in a green-IR-blue-blue pattern, and a fourth row of four pixels are arranged in a green-green-blue-blue pattern. In FIG. 1D, a first row of four pixels is arranged in a red-red-green-green pattern, a second row of four pixels are arranged in a red-IR-IR-green pattern, a third row of four pixels are arranged in a green-IR-IR-blue pattern, and a fourth row of four pixels are arranged in a green-green-blue-blue pattern. In FIG. 1E, each of a first row and second row of four pixels are arranged in a red-red-green-green pattern, and each of a third row and fourth row of four pixels are arranged in a IR-IR-blue-blue pattern. In FIG. 1F, a first row of four pixels is arranged in a red-green-red-green pattern, a second row of four pixels are arranged in a green-blue-IR-blue pattern, a third row of four pixels are arranged in a red-IR-red-green pattern, and a fourth row of four pixels are arranged in a green-blue-green-blue pattern. Note, these pixel sensor arrangements illustrated in FIGS. 1A-1F are merely a few examples. In other embodiments, a sensing module may have different pixel sensor arrangements or have different dimension that is greater or smaller than 4×4.

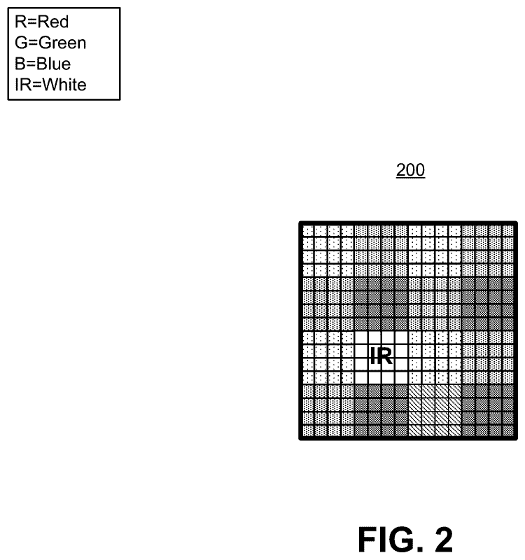

For example, FIG. 2 illustrates an example of a 16×16 multi-pixel sensing array 200 in accordance with one or more embodiments. As illustrated, the sensing array 200 includes 16 4×4 sensing blocks. Each of the 4×4 sensing blocks has 16 same color pixel sensors arranged in a 4×4 array. For example, a top row includes two 4×4 red sensing blocks and two 4×4 green sensing blocks, alternately arranged. Each of a second row and a bottom row includes two 4×4 green sensing blocks and two 4×4 blue sensing blocks alternately arranged. A third row includes a 4×4 red sensing block, followed by a 4×4 IR sensing block, followed by another 4×4 red sensing block, followed by a 4×4 green sensing block.

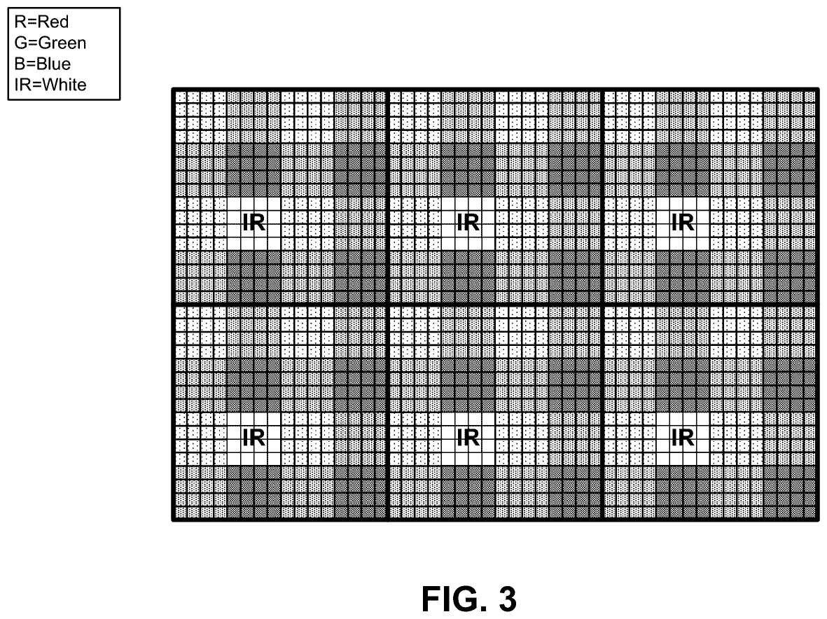

Multiple sensing modules may be arranged together to form a sensing system having an overall greater sensing array. In some embodiments, for each color sensor, a color filter is placed over an optical sensor. For example, a red sensor has a red color filter placed over an optical sensor. Referring to FIG. 3, six 16×16 identical sensing modules corresponding to the sensing array shown in FIG. 2 are arranged in a 3×2 array to form a sensing system having an overall sensing array of 48×32 pixels. Such an array with multiple identical sensing modules is also called a uniform filter array.

In some embodiments, a spatially-varying filter array may be implemented. A spatially-varying filter array is an array of sensing modules that have different sensing arrays. Unlike a uniform filter array, where all the sensing modules in the array are identical, a spatially-varying filter array has sensing modules that are different.

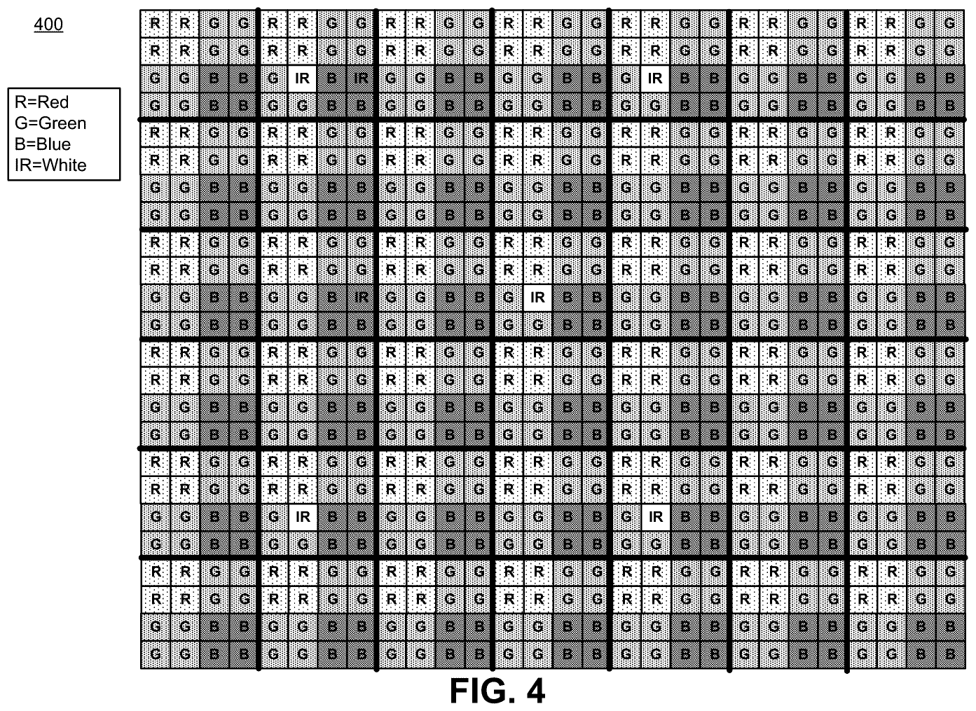

FIG. 4 illustrates an example spatially-varying filter array 400 including 42 (=6×7) 4×4 sensing modules. Some of these 4×4 sensing modules include an IR sensor, and the rest of them only have RGB sensors. For example, the top left 4×4 sensing module includes four 2×2 sensing blocks, namely, a 2×2 red block, two 2×2 green blocks, and a 2×2 blue block. A second top left 4×4 sensing module is near identical to the top left 4×4 sensing module, except that one of the green pixel sensors is replaced with an IR sensor. As illustrated, the spatial-varying filter array 400 includes a total of five such sensing modules with an IR sensor.

For each sensing module, in addition to the sensing array, there is a single ADC shared by the multiple pixel sensors. The sensors in the sensing array are connected to the ADC via a multiplexer. The multiplexer is configured to sequentially or selectively obtain sensing data from the multiple pixel sensors.

FIG. 5 illustrates an example architecture of the sensing module 500. As illustrated, the sensing module 500 includes an N×M sensing array 502, which may correspond to a sensing array illustrated in FIGS. 1A-1F, 2, or 3. The N×M sensors in the sensing array 502 are connected to an ADC 506 via a multiplexer 504. Each of the N×M sensors is configured to generate analog sensing data. The multiplexer 504 selectively passes the analog sensing data from one of the N×M sensors to the ADC 506, causing the ADC to convert the received analog sensing data into digital sensing data, and store the digital sensing data in a memory 508. The memory 508 may be a Random Access Memory (RAM), e.g., a Static Random Access Memory (SRAM). In some embodiments, RAM is often a volatile memory used to store data temporarily for quick access during processing tasks. An image-sensing system (including multiple sensing modules 500) may also include one or more processors configured to access the RAM to obtain digital sensing data stored therein.

Depending on the operation mode of the image-sensing system, the multiplexer 504 may be configured to sequentially activate each of the optical sensors in the N×M sensing array, causing the sensing data from each of the N×M sensors to be obtained sequentially, achieving maximum image quality. In some modes, the multiplexer 504 may be configured to sequentially activate a subset of the optical sensors in the N×M sensing array, causing the sensing data of the subset of the optical sensors to be obtained sequentially, achieving higher sensing speed, or obtaining IR data.

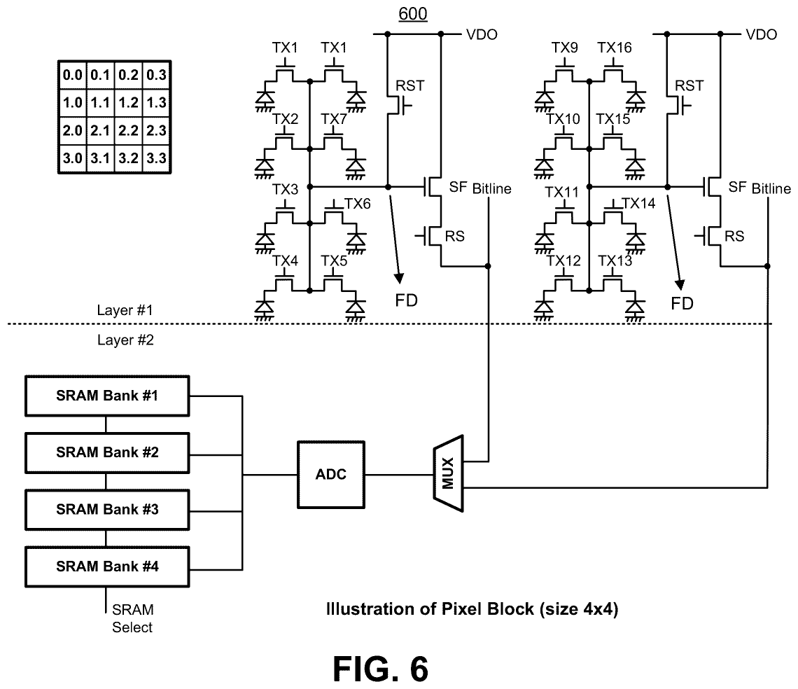

FIG. 6 illustrates an example circuit diagram for a 4×4 sensing module 600. The 4×4 sensing module 600 includes a 4×4 sensor array, which may correspond to any sensor array illustrated in FIGS. 1A-1F. In some embodiments, each sensor includes a floating diffusion (FD) node where charge collected from a photodiode (PD) is transferred before it gets converted into a voltage. The charge stored in the FD node is eventually read out and converted into a voltage by a source-following (SF) transistor.

As illustrated in FIG. 6, there are 16 photodiodes (FD) (which are optical sensors) configured to detect and convert light into an electrical current. When an FD is exposed to light, photons interact with the semiconductor material to generate a current proportional to the intensity of the incident light. Further, each of the 16 FDs is connected to a transistor TX1-TX16 configured to convert the current signal generated by a corresponding FD into a voltage signal. Also, each transistor TX1-TX16 may be turned on or off based on a signal applied to their corresponding gate. When the transistor TX1-TX16 is turned on, the current signal generated by a corresponding FD is converted into a voltage signal and passed on to the FD node.

The 16 transistors TX1-TX16 are grouped into two groups. On the left side, a first group of transistors include transistors TX1-TX8. A drain of each of the transistors TX1-TX8 are connected together to a first reset transistor RST. On the right side, a second group of transistors include transistors TX9-TX16. A drain of each of the transistors TX9-TX16 are connected together to a second reset transistor RST. Each rest transistor RST is configured to reset a voltage level of the FD node before new charge from a PD is transferred into it. This process ensures that each new frame starts with a clean state.

A first analog signal from one of the transistors TX1-TX8 is read at a first bit line, and a second analog signal read from one of the transistors TX9-TX16 is read at a second bit line. The first analog signal and the second analog signal are input into a multiplexer. In different modes, a different number of the transistors TX1-TX8 may be sequentially or simultaneously turned on, and the analog sensing data of the corresponding sensor(s) may be read at the corresponding bit line. The sequence of the activation of the transistors TX1-TX16 can be changed dynamically.

The multiplexer selectively passes the first analog signal or the second analog signal to the ADC. The ADC converts the received analog signal into a digital signal, and causes the digital signal to be stored at one of the SARM banks 1-4. In some embodiments, parallel SRM read and/or read may be implemented to simultaneously reading and writing signals from the transistors TX1-TX16.

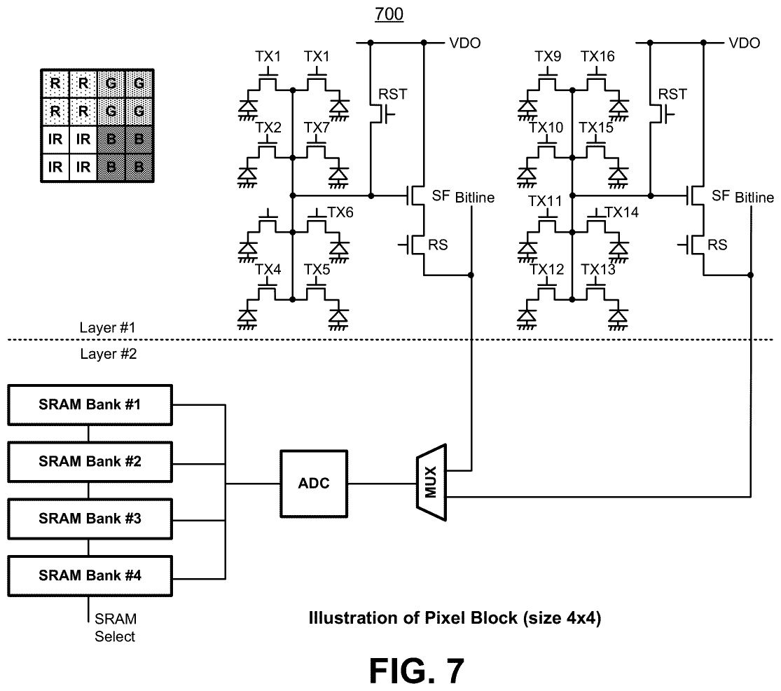

FIG. 7 illustrates an example circuit diagram for a 4×4 sensing module 700, in which a sensing pixel has four blocks of 2×2 pixel sensors. The top left block includes 4 red pixel sensors, top right block includes 4 green pixel sensors, the bottom left block includes 4 IR pixel sensors, and the bottom right block includes 4 blue pixel sensors.

In some embodiments, each of the 2×2 blocks shares a common FD node. Because multiple PDs share a common FD node, it is possible to synchronize the charge transfer process (via pulsing the transistor gates) such that analog charge binning can be implemented for these PDs. “Analog charge binning” is a method used in imaging devices to combine the electric charge collected by multiple PDs into a single “bin” or composite pixel. This binning process is performed in the analog domain, which means the electrical charge is combined before it is converted into digital values for image processing. The advantage of analog charge binning is increased sensitivity, as the combined charges effectively capture more light, making it beneficial for low-light conditions. However, this comes at the expense of spatial resolution, as multiple PDs contribute to a single output pixel. Depending on applications or operation modes, an analog charge binning mode can be turned on or off. When it is turned on, the electric charges of the four pixels in each block are combined and simultaneously collected into a composite pixel. As illustrated, when the top left block is activated in an analog charge binning mode, the four-pixel sensors of the top left block (red) are combined and simultaneously collected into a composite pixel.

### Example Image-Sensing System

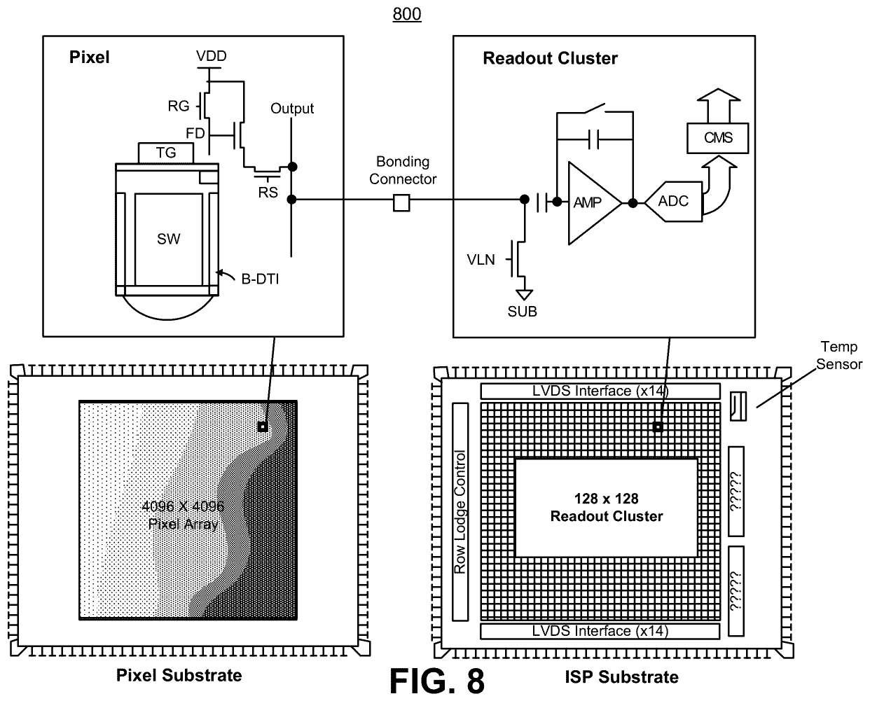

As briefly discussed above, an image-sensing system may include multiple sensing modules. FIG. 8 illustrates an example image-sensing system 800 in accordance with some embodiments. As illustrated, the image-sensing system 800 includes a pixel substrate and an image signal processor (ISP) substrate. The pixels substrate includes a pixel sensor array of 4096×4096. The ISP substrate includes a readout cluster array of 128×128, each corresponding to a 32×32 pixel sensor module (similar to the 4×4 sensor module illustrated in FIG. 7). As such, each readout cluster shares a single ADC configured to read out sensing data in its corresponding 32×32 pixel sensor module. The output of the ADC can then be sent to a color management system (CMS) to be further processed.

The image-sensing system 800 may operate in multiple modes, such as image capture mode, scanning depth sensing mode, IR mode, sparse sensing mode, etc. In some embodiments, when the image-sensing system 800 operates in the sparse sensing mode, charge binning is performed, causing multiple sensor's sensing signals (in each or a subset of the 32×32 pixel sensor modules) to be binned into a single sensing signal. In some embodiments, when the sensing system operates in the image capture mode, only the RGB pixel sensors are activated and configured to capture an RGB image. In some embodiments, when the sensing system operates in the IR mode, only IR pixel sensors are activated and configured to capture IR pictures.

In some embodiments, IR pixels can be captured in different ways. In some embodiments, they can be captured simultaneously with RGB pixels in a single exposure, resulting in temporarily aligned RGB-D data. Alternatively, in some embodiments, they can be captured in a sequential manner, such as capturing a depth frame followed by an RGB frame.

In a single-exposure RGB-D scenario, a common FD node constrains the timing for the rest, integration, and readout or quantization of RGB-D pixels. With a shared FD architecture, the resetting of individual pixels coincides with the FD reset. As a result, an IR pixel can't start accumulating charges on the shared FD node until all other pixels have been reset and have initiated their integration phase.

In some embodiments, a rolling or global reset may be implemented. A rolling reset ensures uniform exposure time for all pixels in the cluster but shortens the exposure time for the IR pixel. On the other hand, a global reset optimizes the exposure time for the IR pixel at the expense of creating spatial variation in exposure times across the cluster.

In some embodiments, various sensing modes may also be implemented, including, but not limited to rolling shutter (RS) mode, global shutter (GS) mode, sparse sensing mode, binning mode, etc.

### Example Operation Modes

In some embodiments, in rolling shutter (RS) mode, unlike traditional RS mode, the sensor system scans across pixel blocks (e.g., 128×128 blocks) instead of along individual pixel columns. In some embodiments, instead of all pixels in a row sharing a row-select switch, pixels at a certain block location, e.g., (1, 1) in different blocks share an RS switch. The result is that shutter artifacts present both along x and y directions but are localized within pixel blocks. In some embodiments, scan direction and order can be arbitrarily chosen.

In some embodiments, ADC can also combine multiple shared FD nodes. In some embodiments, IR pixels can operate independently from reset, exposure, and quantization and/or readout operations of all pixels that share a separate FD node.

In some embodiments, global shutter mode (GS) operation can be achieved by either capturing a single pixel per block or by binning a group of pixels in each block into a single signal to quantize. In GS mode, the sensor operates as a digital pixel sensor with pixel-parallel ADCs. Similarly, pseudo-GS operation can be achieved by capturing a small set of more than one pixel. While the ADC sequentially captures and quantizes pixels, the scan speed can be very short due to the small number of pixels being quantized. An example of pseudo-GS operation is a 16×16 pixel block being binned down to a 2×2 group of pixels to capture. Scan speed for a group of 4 pixels can be small compared to that of a full-resolution block and exposure time. For example, if the time required to reset and quantize a single pixel is 5 microseconds, then the scan duration for a 2×2 binned block would be 20 microseconds. In contrast, a 16×16 block would take 1.3 milliseconds to scan.

In some embodiments, in sparse sensing mode, instead of collecting a large, dense set of pixels, sparse sensing aims to acquire a smaller, “sparse” set of pixels that still enables sufficiently accurate reconstruction or analysis of a target area. For example, only a subset of pixel sensors are used to capture an image. This is particularly useful in situations where full data acquisition is too time-consuming or energy-consuming. In certain applications, sparse sensing is sufficient to capture essential information with high temporal resolution and low data bandwidth. For example, in anomaly detection, sparse sensing can be implemented to detect abnormal patterns with fewer measurements. In certain applications, only the IR sensors in the array are activated. Advanced depth algorithms can further be implemented to refine a depth map.

In some embodiments, each pixel block can include a memory to store an activation state to be used in sparse sensing mode. State 0 can disable the ADC, SF, and SRAM. This activation memory can be dynamically programmed with a single frame and/or across multiple frames. For example, the state bit can be set in ON state for pixels 1-4 of a block, then OFF for pixels 5-8, then again ON for pixels 9-16. Similar power gating can be used for column and row control signals (e.g., digital ramp, bit-line precharge, analog ramp, etc.). Again, for a single frame, these signals can be enabled or disabled dynamically for individual pixels within a pixel block (and across frames).

In some embodiments, in the scanning depth sensing mode, structured IR light is projected on a surface (e.g., by a light projector). In some embodiments, the structured IR light includes a dot that scans across a scene. The dot is often referred to as a scanning dot or a flying dot. The IR pixel sensors are configured to detect the timing of the scanning dot as it moves across the scene. When the scanning dot scans or flies across the scene, each IR pixel in the sensor captures the exact moment it is illuminated by this dot. By knowing the timing and possibly the position of the illumination, the sensor can triangulate the depth or distance of various points in the scene, creating a depth map.

In some embodiments, in the scanning depth sensing mode, IR pixels (either single pixels or binned pixels) are connected directly to the block-level ADC during exposure time. Pixels can either be configured in lateral overflow field-induced collection mode (OFIC mode) or with transfer gate (TG gate) held in ON or partially ON state. OFIC mode refers to an operating mode where the lateral overflow and field-induced collection phenomena are deliberately manipulated or managed for specific imaging applications. In either case, photo-generated carriers or charges are converted to a voltage on the FD node. The FD node is monitored by the ADC during exposure time. As charges accumulate on the FD node, its voltage drops from its reset level. A comparator detects when the FD node voltage drops below some threshold voltage (saturation level). The time it takes to reach saturation is linked to the moment a scanning light source illuminates a specific pixel. With a predefined scanning pattern, this timing data can be employed to calculate the depth of the scene.

To enable the scanning depth sensing mode, different sub-modes may be implemented. One of these sub-modes is Time-to-Saturate” (TTS) mode. TTS mode is used to measure the time it takes for a PD (PD) or pixel to reach a saturation level. The sensor measures how long it takes for the voltage on the FD node to drop from its reset level to a certain threshold or saturation level as photo-generated charges accumulate. In applications like structured light depth sensing, the time-to-saturate can be correlated with the time at which an illuminated IR dot appears on a pixel. This helps in estimating the depth of the scene.

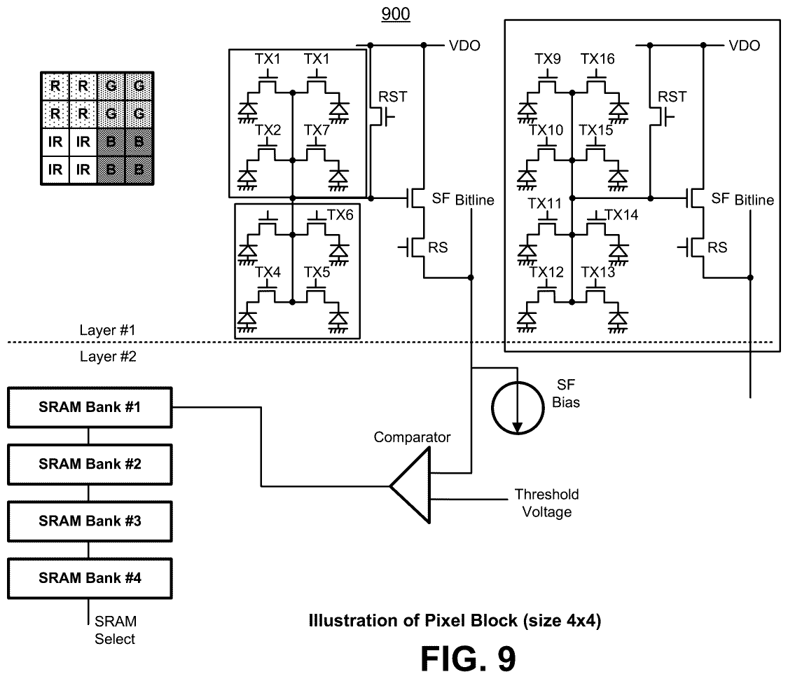

FIG. 9 illustrates an example circuit diagram for a 4×4 sensing module 900, operating in the TTS mode. As illustrated in FIG. 9, the transistors TX1, TX2, TX7, and TX8 are connected to IR PDs, and these SF transistors are turned on to allow sensing data generated by the IR PDs to be passed to the FD node. The comparator is configured to receive the sensing data (e.g., sensing voltage) and compare the sensing voltage with a threshold voltage to determine whether the sensing voltage reaches the threshold voltage, and a timer (not shown) is configured to track the time it takes for the voltage on the FD node to drop from its reset level to a certain threshold.

Alternatively, another mode for depth-sensing operation is temporal contrast (TC) mode. In TC mode, each block can incorporate a temporal contrast section before the thresholding stage, in addition to the ADC and comparator components. In TC mode, the sensor generates events only when there is a change in the intensity of light falling on a pixel by a certain threshold. In other words, instead of capturing a whole frame, each pixel independently triggers an event if the light intensity changes. These events can be either positive (indicating an increase in intensity) or negative (indicating a decrease). This would mitigate the impact of ambient light and leakage currents that could introduce noise into depth assessments.

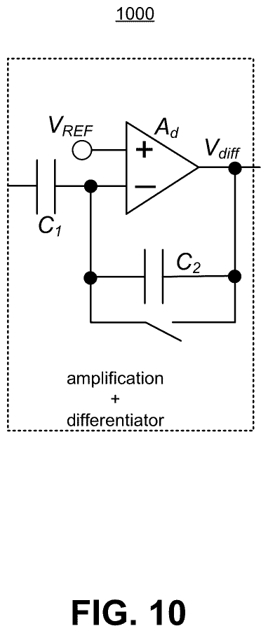

FIG. 10 illustrates an example circuit 1000 of temporal contrast section. The circuit includes an amplifier configured to receive a signal voltage and a reference voltage. The difference between the signal voltage and the reference voltage are compared and amplified to detect a change.

### Example Timing Diagrams

As described above, the image-sensing system 800 may be configured to operate in different reset modes and/or sensing modes. The different modes can be activated via a control signal at the reset transistor RST, control signals at a gate of a SF transistor TX1-TX16, a control signal at the ADC, a control signal at block SRAM, etc.

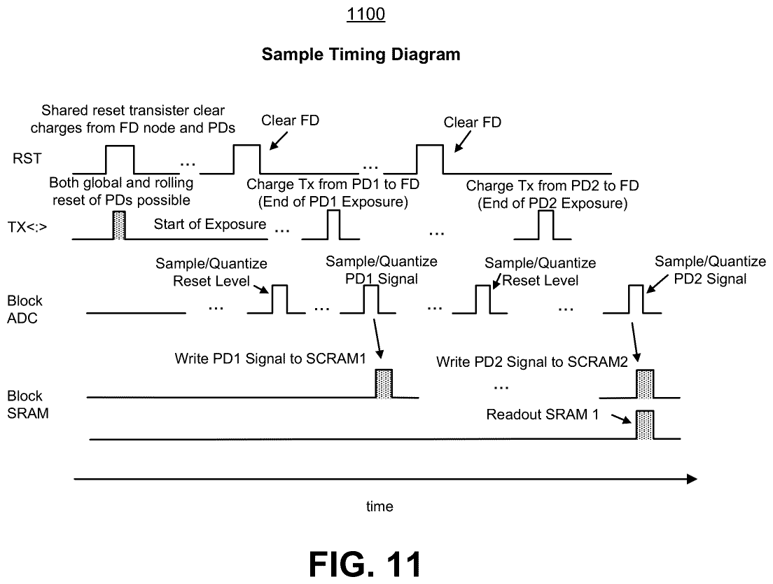

FIG. 11 illustrates an example of a sample timing diagram 1100 according to one or more embodiments. The sample timing diagram 1100 includes a reset signal (which may be a control signal at the gate of the reset transistor RST), a TX signal (which may be a control signal at a gate of SF transistor TX1-TX16), a block ADC signal (which may be a control signal at the ADC or the multiplexer), and multiple block SRAM signals (which may be a control signal at the multiple blocks of SRAMs).

In image capture mode, the reset signal of PDs can either occur in parallel or sequentially, which enables either global reset or rolling reset mechanisms. Based on the timing diagram 1100, the reset of PD occurs in parallel, i.e., all the PDs are reset simultaneously when a pulse in the reset signal is high. The TX signal is configured to control one of the transistors TX 1-TX16. When the pulse in the TX signal is high, the corresponding transistor is caused to charge from PD to FD. Even though only one TX signal is illustrated, there may be 8 or 16 TX signals, with a pulse signal sequentially after a previous TX signal. As such, each of the transistors TX1-TX8 or TX9-TX16 may be sequentially or simultaneously turned on and off based on the TX signal.

The block ADC signal is configured to sequentially read a signal from each PD within a block from the transistors TX1-TX8 or TX9-TX16. For example, when a pulse in the block ADC signal is high, the received analog signal is quantized into a digital signal. The block SRAM signal is configured to write the digital signal generated by the ADC into an SRAM. When a pulse in the block SRAM signal is high, a digital signal is written into the SRAM.

In some embodiments, an order of quantization can be arbitrarily chosen and dynamically changed from frame to frame. For example, during frame 1, PD order can be 1, 2, 3, 4; during frame 2, the PD order can be 5, 1, 3, 2, where the numbers 1-5 are identifiers of the PDs. For example, referring to FIG. 6, the optical sensors or PDs are numbered as (0, 0), (0, 1), (0, 2), (0, 3), (1, 0), . . . (3, 3). Sensing data from each of the 16 sensors, or a subset of the 16 sensors can be read and quantized in any arbitrarily chosen order.

FIG. 11 illustrate analog correlated double sampling (CDS) operation, but digital CDS can also be supported with an additional SRAM write operation per pixel (to write reset level into SRAM). In an analog CDS operation, the voltage level of a pixel is measured twice: once right after the pixel is reset and again after the charge has been collected due to exposure to light. These two measurements are taken in the analog domain, and the first measurement (reset level) is subtracted from the second measurement (signal level) to obtain a value that is more representative of the actual light intensity hitting the pixel. In a digital CDS operation, both of the measured voltage levels of the pixel are converted to digital form via an ADC. The digital reset level is then subtracted from the digital signal level to yield a final value.

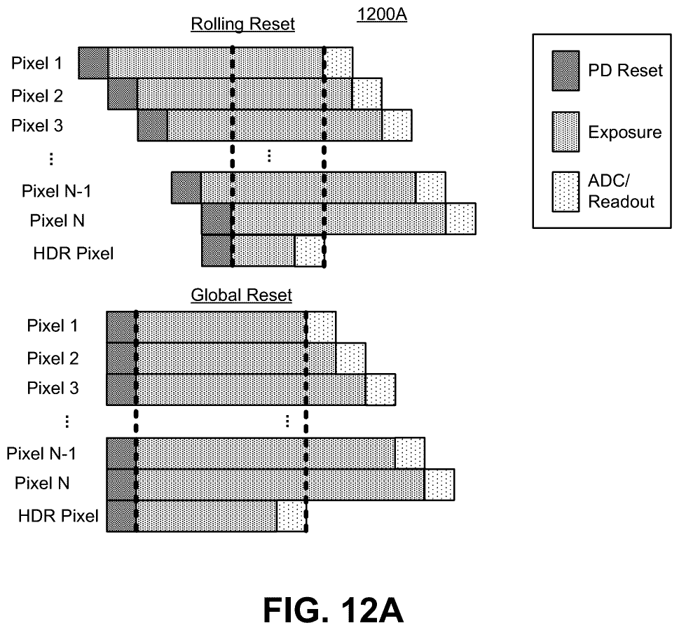

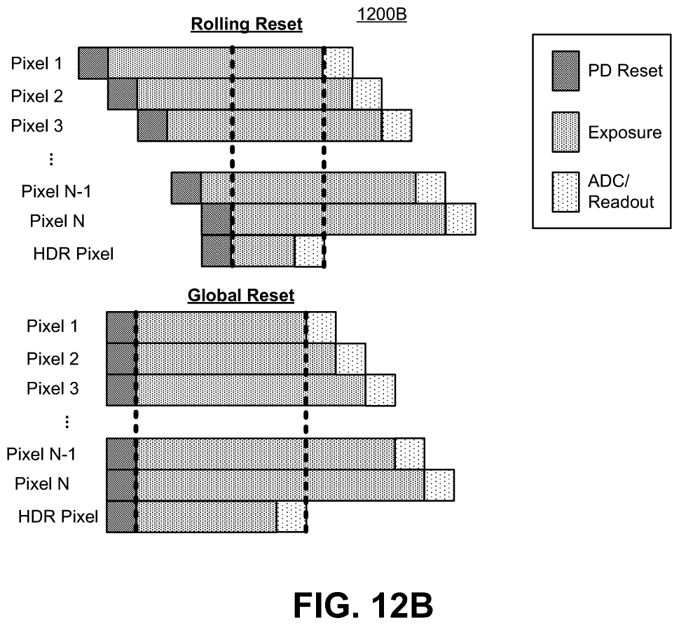

Resetting of each pixel in each sensing block may be performed sequentially (also referred to as “rolling reset”) or simultaneously (also referred to as “global reset”). FIG. 12A illustrates an example timing diagram 1200A for rolling reset and global reset. In some embodiments, rolling reset or global reset can be selectively implemented. The top part of the diagram 1200A illustrates timings of multiple pixels (including N pixels and an IR pixel) in a block module when rolling reset is performed. During rolling reset, each of the N pixels sequentially reset, then sequentially exposes for a time period, and finally readout by ADC. The IR pixel is reset simultaneously with the last pixel (pixel N). Exposure time of the IR pixel is shorter than the rest of the pixels, such that the readout of the IR pixel is performed before the readouts of all the N pixels.

The bottom part of the diagram 1200A illustrates timings of multiple pixels (including N pixels and an IR pixel) in a block module when global reset is performed. During global reset, each of the N pixels and the IR pixel are reset simultaneously. A first pixel (pixel 1) is exposed for a first time period, a second pixel (pixel 2) is exposed for a second time period greater than the first time period, a third pixel (pixel 3) is exposed for a third time period greater than the second time period, and so on and so forth. As such, readout of each of the N pixels can be performed sequentially by the ADC. The IR pixel is exposed for a shorter period than all the N pixels, such that the readout of the IR pixel is performed before the readouts of all the N pixels.

In existing image-sensing systems, capturing high-quality high dynamic range (HDR) images using high-resolution RGB sensors present a complex set of challenges. Existing HDR techniques such as Interlaced HDR, Zigzag HDR, Quad HDR, Staggered HDR, and Coded Exposure HDR come with their own issues. These often involve problems like ghosting or motion artifacts and a decrease in spatial resolution or spatial resolution in favor of enhancing the dynamic range, particularly in high-light conditions.

The image-sensing system described herein also enables a new HDR mode that can prioritize low-light performance at the expense of spatial resolution under high-light conditions. This mode utilizes a block-level ADC architecture that combines RS with either a LOFIC-like dual quantization mode or a triple quantization scheme, which includes high gain, low gain, and time-to-saturate options. In some embodiments, there is an HDR pixel in at least one sensing module of the image-sensing system. In some embodiments, the HDR pixel includes a clear, white, and/or mono color filter configured to maximize signal collection and/or bandwidth.

FIG. 12B illustrates an example timing diagram 1200B for rolling reset and global reset in sensing blocks with HDR pixels. The top part of the diagram 1200 illustrates timings of multiple pixels (including N pixels and an HDR pixel) in a block module when rolling reset is performed. During rolling reset, each of the N pixels sequentially reset, then sequentially exposes for a time period, and finally readout by ADC. The IR pixel is reset simultaneously with the last pixel (pixel N). Exposure time of the IR pixel is shorter than the rest of the pixels, such that the readout of the HDR pixel is performed before the readouts of all the N pixels.

The bottom part of the diagram 1200B illustrates timings of multiple pixels (including N pixels and an HDR pixel) in a block module when global reset is performed. During global reset, each of the N pixels and the HDR pixel are reset simultaneously. A first pixel (pixel 1) is exposed for a first time period, a second pixel (pixel 2) is exposed for a second time period greater than the first time period, a third pixel (pixel 3) is exposed for a third time period greater than the second time period, and so on and so forth. As such, readout of each of the N pixels can be performed sequentially by the ADC. The HDR pixel is exposed for a shorter period than all the N pixels, such that the readout of the HDR pixel is performed before the readouts of all the N pixels.

Once all pixels in a cluster have begun exposure, the FD node is available to accumulate overflow charge from an HDR pixel. During the exposure time of the HDR pixel, TTS mode can be enabled. Once TTS mode is completed, a low conversion gain mode can be executed to quantize any residual overflow charges that were not sensed in TTS mode. A high conversion gain mode can also be executed to detect any charges in the PD, in the event that there was no overflow from the PD.

In some embodiments, if a cluster module includes more than one FD node, a single DC can facilitate HDR mode for multiple pixels at the same time. this can be accomplished by time-multiplexing the ADC across the various FD nodes. In certain implementations, a multiplexer may be situated between each FD node and the ADC, allowing the ADC to simultaneously monitor overflow charges across multiple FD nodes. In some configurations, each cluster might require at least one memory bank for each FD node.

### Example Headset

Embodiments of the invention, e.g., the image-sensing system, may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

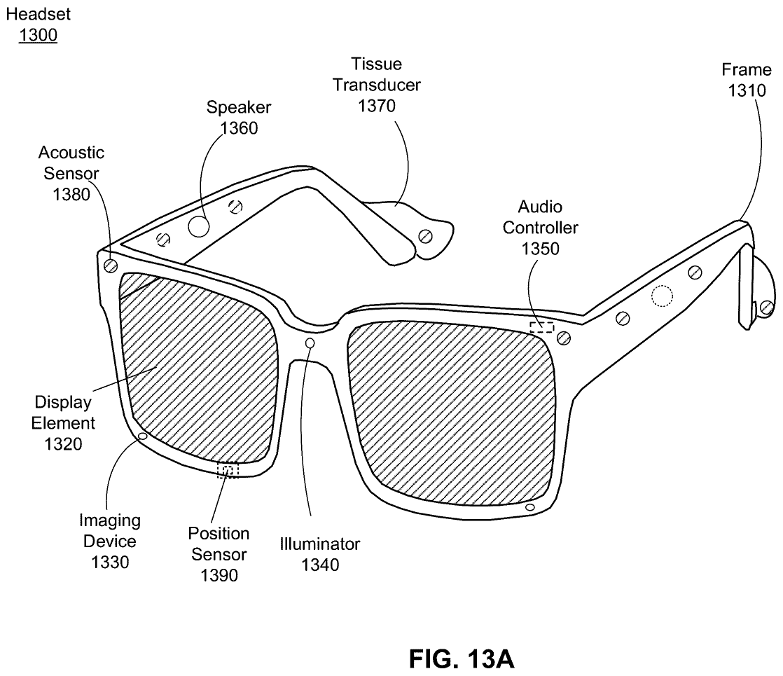

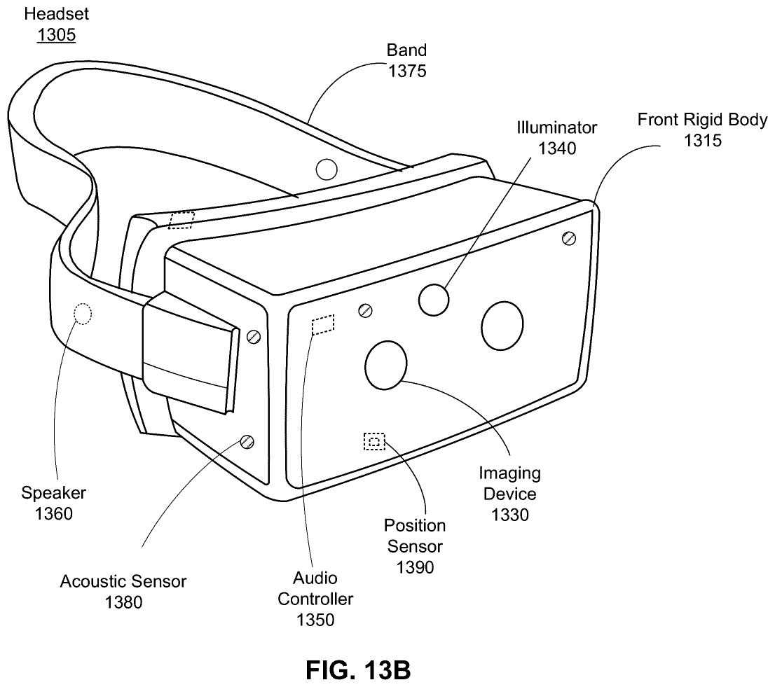

FIG. 13A is a perspective view of a headset 1300 implemented as an eyewear device, in accordance with one or more embodiments. In some embodiments, the eyewear device is a near eye display (NED). In general, the headset 1300 may be worn on the face of a user such that content (e.g., media content) is presented using a display assembly and/or an audio system. However, the headset 1300 may also be used such that media content is presented to a user in a different manner. Examples of media content presented by the headset 1300 include one or more images, video, audio, or some combination thereof. The headset 1300 includes a frame, and may include, among other components, a display assembly including one or more display elements 1320, an imaging device 1330 (which may correspond to an image-sensing system 800 of FIG. 8), an audio system, and a position sensor 1390. While FIG. 13A illustrates the components of the headset 1300 in example locations on the headset 1300, the components may be located elsewhere on the headset 1300, on a peripheral device paired with the headset 1300, or some combination thereof. Similarly, there may be more or fewer components on the headset 1300 than what is shown in FIG. 13A.

The frame 1310 holds the other components of the headset 1300. The frame 1310 includes a front part that holds the one or more display elements 1320 and end pieces (e.g., temples) to attach to a head of the user. The front part of the frame 1310 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 1320 provide light to a user wearing the headset 1300. As illustrated the headset includes a display element 1320 for each eye of a user. In some embodiments, a display element 1320 generates image light that is provided to an eyebox of the headset 1300. The eyebox is a location in space that an eye of user occupies while wearing the headset 1300. For example, a display element 1320 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 1300. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 1320 are opaque and do not transmit light from a local area around the headset 1300. The local area is the area surrounding the headset 1300. For example, the local area may be a room that a user wearing the headset 1300 is inside, or the user wearing the headset 1300 may be outside and the local area is an outside area. In this context, the headset 1300 generates VR content. Alternatively, in some embodiments, one or both of the display elements 1320 are at least partially transparent, such that light from the local area may be combined with light from the one or more display elements to produce AR and/or MR content.

In some embodiments, a display element 1320 does not generate image light, and instead is a lens that transmits light from the local area to the eyebox. For example, one or both of the display elements 1320 may be a lens without correction (non-prescription) or a prescription lens (e.g., single vision, bifocal and trifocal, or progressive) to help correct for defects in a user's eyesight. In some embodiments, the display element 1320 may be polarized and/or tinted to protect the user's eyes from the sun.

In some embodiments, the display element 1320 may include an additional optics block (not shown). The optics block may include one or more optical elements (e.g., lens, Fresnel lens, etc.) that direct light from the display element 1320 to the eyebox. The optics block may, e.g., correct for aberrations in some or all of the image content, magnify some or all of the image, or some combination thereof.

The imaging device 1330 determines depth information for a portion of a local area surrounding the headset 1300. The imaging device 1330 includes one or more imaging devices 1330 and an imaging device 1330 controller (not shown in FIG. 13A), and may also include an illuminator 1340. In some embodiments, the illuminator 1340 illuminates a portion of the local area with light. The light may be, e.g., structured light (e.g., dot pattern, bars, etc.) in the infrared (IR), IR flash for time-of-flight, etc. In some embodiments, the one or more imaging devices 1330 capture images of the portion of the local area that include the light from the illuminator 1340. As illustrated, FIG. 13A shows a single illuminator 1340 and two imaging devices 1330. In alternate embodiments, there is no illuminator 1340 and at least two imaging devices 1330.

The imaging device 1330 controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 1340), some other technique to determine depth of a scene, or some combination thereof.

The audio system provides audio content. The audio system includes a transducer array, a sensor array, and an audio controller 1350. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 1360 or a tissue transducer 1370 (e.g., a bone conduction transducer or a cartilage conduction transducer). Although the speakers 1360 are shown exterior to the frame 1310, the speakers 1360 may be enclosed in the frame 1310. In some embodiments, instead of individual speakers for each ear, the headset 1300 includes a speaker array comprising multiple speakers integrated into the frame 1310 to improve directionality of presented audio content. The tissue transducer 1370 couples to the head of the user and directly vibrates tissue (e.g., bone or cartilage) of the user to generate sound. The number and/or locations of transducers may be different from what is shown in FIG. 13A.

The sensor array detects sounds within the local area of the headset 1300. The sensor array includes a plurality of acoustic sensors 1380. An acoustic sensor 1380 captures sounds emitted from one or more sound sources in the local area (e.g., a room). Each acoustic sensor is configured to detect sound and convert the detected sound into an electronic format (analog or digital). The acoustic sensors 1380 may be acoustic wave sensors, microphones, sound transducers, or similar sensors that are suitable for detecting sounds.

In some embodiments, one or more acoustic sensors 1380 may be placed in an ear canal of each ear (e.g., acting as binaural microphones). In some embodiments, the acoustic sensors 1380 may be placed on an exterior surface of the headset 1300, placed on an interior surface of the headset 1300, separate from the headset 1300 (e.g., part of some other device), or some combination thereof. The number and/or locations of acoustic sensors 1380 may be different from what is shown in FIG. 13A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 1300.

The audio controller 1350 processes information from the sensor array that describes sounds detected by the sensor array. The audio controller 1350 may comprise a processor and a computer-readable storage medium. The audio controller 1350 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 1360, or some combination thereof.

The position sensor 1390 generates one or more measurement signals in response to motion of the headset 1300. The position sensor 1390 may be located on a portion of the frame 1310 of the headset 1300. The position sensor 1390 may include an inertial measurement unit (IMU). Examples of position sensor 1390 include: one or more accelerometers, one or more gyroscopes, one or more magnetometers, another suitable type of sensor that detects motion, a type of sensor used for error correction of the IMU, or some combination thereof. The position sensor 1390 may be located external to the IMU, internal to the IMU, or some combination thereof.

In some embodiments, the headset 1300 may provide for simultaneous localization and mapping (SLAM) for a position of the headset 1300 and updating of a model of the local area. For example, the headset 1300 may include a passive camera assembly (PCA) that generates color image data. The PCA may include one or more RGB cameras that capture images of some or all of the local area. In some embodiments, some or all of the imaging devices 1330 of the imaging device 1330 may also function as the PCA. The images captured by the PCA and the depth information determined by the imaging device 1330 may be used to determine parameters of the local area, generate a model of the local area, update a model of the local area, or some combination thereof. Furthermore, the position sensor 1390 tracks the position (e.g., location and pose) of the headset 1300 within the room.

FIG. 13B is a perspective view of a headset 1305 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 1315 and a band 1375. The headset 1305 includes many of the same components described above with reference to FIG. 13A, but modified to integrate with the HMD form factor. For example, the HMD includes a display assembly, a imaging device 1330, an audio system, and a position sensor 1390. FIG. 13B shows the illuminator 1340, a plurality of the speakers 1360, a plurality of the imaging devices 1330, a plurality of acoustic sensors 1380, and the position sensor 1390. The speakers 1360 may be located in various locations, such as coupled to the band 1375 (as shown), coupled to front rigid body 1315, or may be configured to be inserted within the ear canal of a user.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. An image-sensing system, comprising:
a plurality of sensing modules, each of the plurality of sensing modules comprising:
a plurality of optical sensors arranged in an array, each of the plurality of optical sensors configured to be switched on and off to generate analog sensing data; and
an analog-to-digital converter (ADC) shared by the plurality of optical sensors configured to convert analog sensing data generated by the plurality of optical sensors into digital data; and
a processor configured to control the plurality of sensing modules.

2. The image-sensing system of claim 1, wherein the plurality of sensing modules are identical.

3. The image-sensing system of claim 1, wherein only a subset of the plurality of sensing modules include an infrared sensor.

4. The image-sensing system of claim 1, wherein each of the plurality of sensing modules includes a plurality of blocks, each of the plurality of blocks includes a same number of optical sensors.

5. The image-sensing system of claim 4, wherein sensors in at least one of the plurality of blocks share a floating diffusion node.

6. The image-sensing system of claim 5, wherein the image-sensing system is configured to operate in a plurality of modes, the plurality of modes including a binning mode,
in the binning mode, the processor configured to:
cause sensing signals generated by each sensor in at least one of the plurality of blocks to be combined into a single sensing signal;
cause the single sensing signal to be received by the ADC; and
cause the ADC to convert the single sensing signal into a single digital signal.

7. The image-sensing system of claim 5, wherein the plurality of blocks includes a first block and a second block, and wherein the first block includes sensors configured to capture light in a first bandwidth, and the second block includes sensors configured to capture light in a second bandwidth different from the first bandwidth.

8. The image-sensing system of claim 5, wherein the plurality of blocks include a block of red sensors, a block of green sensors, and a block of blue sensors.

9. The image-sensing system of claim 8, wherein the plurality of blocks further include a block of infrared sensors.

10. The image-sensing system of claim 8, wherein the plurality of blocks further include a block of high dynamic range sensors.

11. The image-sensing system of claim 1, further comprising a light projector configured to project light, wherein the image-sensing system is configured to operate in a plurality of modes, the plurality of modes including a depth sensing mode,
in the depth sensing mode, the processor configured to:
cause the light projector projects a scanning light dot across an area;
cause at least one sensor in at least one of the plurality of sensing modules to detect timings of a scanning dot as the scanning dot moves across the area; and
determine a depth of different points in the area based on the detected timings and corresponding locations of the scanning dot.

12. The image-sensing system of claim 11, wherein in the depth sensing mode, detecting timings of the scanning dot as the scanning dot moves across the area comprises:
measuring a time it takes for a voltage on an FD node to drop from a reset level to a predetermined threshold.

13. The image-sensing system of claim 12, wherein each of the plurality of sensing modules comprises a temporal contrast module configured to:
determine whether a change in an intensity of light falling on a pixel is greater than a threshold, and
responsive to determining that the change in the intensity of light falling on the pixel is greater than the threshold, measuring a time it takes for a voltage on the FD node to drop from a reset level to a predetermined threshold.

14. The image-sensing system of claim 1, wherein the image-sensing system is configured to operate in a plurality of modes, the plurality of modes including a rolling shutter mode, and a global shutter mode, wherein:
in the rolling shutter mode, the processor is configured to cause at least one sensor in each of the plurality of sensing modules to be sequentially activated; and
in the global shutter mode, the processor is configured to cause at least one sensor in each of the plurality of sensing modules to be simultaneously activated.

15. The image-sensing system of claim 1, wherein the image-sensing system is configured to operate in a plurality of modes, the plurality of modes including a rolling reset mode, and a global reset mode, wherein:
in the rolling reset mode, the processor is configured to cause all of the plurality of optical sensors in each of the plurality of sensing modules to be sequentially reset; and
in the global reset mode, the processor is configured to cause all of the plurality of optical sensors in each of the plurality of sensing modules to be reset simultaneously.

16. A method of capturing an image by an image-sensing system having a plurality of sensing modules, each of the plurality of sensing modules including an array of pixel sensors, the method comprising:
selecting one of a plurality of modes in which the image-sensing system can operate, the plurality of modes comprising at least a rolling shutter mode and a global shutter mode;
responsive to selecting the rolling shutter mode:
selecting at least one pixel sensor in each of the plurality of sensing modules; and
activating the at least one pixel sensor in each of the plurality of sensing modules of pixel sensors sequentially; and
responsive to selecting the global shutter mode:
selecting at least one pixel sensor in each of the plurality of sensing modules; and
activating the at least one pixel sensor in each of the plurality of sensing modules of pixel sensors simultaneously.

17. The method of claim 16, wherein the plurality of modes further include a binning mode, wherein the method further comprises, responsive to selecting the binning mode:
selecting a plurality of pixel sensors in at least one of the plurality of sensing modules;
activating the plurality of pixel sensors simultaneously to generate a plurality of sensing signals; and
combining the plurality of sensing signals into a single signal.

18. The method of claim 17, wherein the method further comprises, responsive to selecting both the binning mode and the rolling shutter mode:
selecting a plurality of pixel sensors in each of the plurality of sensing modules; and
activating each of the plurality of sensing modules sequentially causing the plurality of pixel sensors in each of the plurality of sensing modules to generate a single sensing signal sequentially, activating each of the plurality of sensing modules comprising:
for each of the plurality of sensing modules:
activating the plurality of pixel sensors in a corresponding block simultaneously to generate a plurality of sensing signals; and
combining plurality of sensing signals into the single signal.

19. The method of claim 17, wherein the method further comprises, responsive to selecting both the binning mode and the rolling shutter mode:
selecting a plurality of pixel sensors in each of the plurality of sensing modules; and
activating each of the plurality of sensing modules simultaneously causing the plurality of pixel sensors in each of the plurality of sensing modules to generate a single sensing signal simultaneously, activating each of the plurality of sensing modules comprising:
for each of the plurality of sensing modules,
activating the plurality of pixel sensors in a corresponding block simultaneously to generate a plurality of sensing signals; and
combining plurality of sensing signals into the single signal.

20. A sensing module comprising:
a plurality of optical sensors arranged in an array, each of the plurality of optical sensors configured to be switched on and off to generate analog sensing data; and
an analog-to-digital converter (ADC) shared by the plurality of optical sensors configured to convert analog sensing data generated by the plurality of optical sensors into digital data,
wherein the sensing module is configured to be coupled with a second sensing module to capture a single frame of image.
